(19) United States
(12) Patent Application Publication
(10) Pub. No.: US 2008/0001961 A1
(43) Pub. Date: Jan. 3, 2008

(54) High Dynamic Range Texture Filtering

(75) Inventors: Kimmo Roimela, Tampere (FI); Tomi Aarnio, Tampere (FI); Joonas Itaranta, Tampere (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/427,826

(22) Filed: Jun. 30, 2006

(51) Int. Cl. G09G 5/00

(52) U.S. Cl. 345/582

(57) ABSTRACT

Bit patterns storing floating point data values are interpreted as integer values during various graphical data processing operations. For example, when bilinearly filtering color intensity data for bitmap regions closest to a designated sampling point, the bit patterns representing each of those color intensities are interpreted as integers instead of floating point values. Bit patterns can also be treated as integers when trilinearly filtering color intensity data from multiple bitmaps. After processing the bit fields as integers, the results are then interpreted as floating point values.

### FIELD OF THE INVENTION

The invention generally relates to three dimensional (3D) computer graphics. In particular, embodiments of the invention relate to devices and methods for performing high dynamic range (HDR) rendering.

### BACKGROUND OF THE INVENTION

In computer graphics, details are frequently added to surfaces of 3D objects through a technique known as texturing. One or more surfaces of the object to be displayed are first identified. Those surfaces can be regularly shaped (e.g., a wall, a surface of a sphere or of a cube, etc.), irregularly shaped (e.g., a complex surface defined by a table of points), or a combination of regular and irregular shapes. A separate image is then mapped onto the surface. One common example is a wall in a computer game. The wall may be defined as a planar surface positioned at a certain location within the graphical universe of the game. That wall can then be represented as a brick wall by mapping points of a separate brickwork pattern image onto points of the wall's planar surface. As the viewer's perspective of the wall changes during game play, the manner in which the texture is applied to the planar wall surface also changes.

In general, mapping a source image (e.g., the brickwork pattern in the above example) to a 3D surface (e.g., a plane) involves sampling texture pixels (or texels) of the source image at the screen pixels corresponding to the surface being generated. Arbitrary processing can then be applied to the sampled texture using one or more pixel shading algorithms. There are typically a fixed number of texture samples per screen pixel. In many practical applications that render images in real-time, this fixed number of samples is one. Thus, filtering is often required during texture sampling in order to remove aliasing artifacts. Such artifacts may appear as high frequency noise in areas where texture is minimized (i.e., where texel density is higher than screen pixel density), or as blockiness and/or jagged edges where texture is magnified (i.e., texel density is lower than screen pixel density).

One known technique for texture filtering combines mip-mapping and linear filtering. In mip-mapping, multiple bitmaps are generated for an image corresponding to the texture. The bitmaps of the texture are at successively reduced levels of detail. For example, one bitmap for a texture may be 256×256 texels in size. Other bitmaps for that same texture may have sizes of 128×128 texels, 64×64 texels, 32×32 texels, 16×16 texels, etc. These images (which are collectively known as an image pyramid for the texture) are prefiltered so as to reduce undersampling and so as to approximate a 1:1 texel-to-screen-pixel ratio. Filtering within and between separate mip-maps is then performed. By way of further example, assume that a texture represented by an image pyramid is to be mapped onto a surface have a screen size (in pixels) that is smaller than one of the texture bitmaps in the pyramid, but that is larger than another of the texture bitmaps in the pyramid. Within each of the two bitmaps bilinear filtering is performed. Bilinear filtering computes a weighted average of the four texels within the larger bitmap that are closest to a sampling point (e.g., a point corresponding to a screen pixel to which part of the texture is being mapped). A weighted average is also computed for four texels within the smaller bitmap that are closest to a sampling point. This is then repeated for other sampling points. Trilinear filtering may also be performed. In trilinear filtering, a weighted average of samples from the larger bitmap and from the smaller bitmap is calculated. Anisotropic filtering may also be performed. In many real-time rendering applications, however, anisotropic filtering is implemented by combining multiple bilinear and/or trilinear samples.

Many existing types of 3D graphics hardware include dedicated units for texture sampling and at least one unit for bilinear filtering. When performing HDR texturing, the pixel intensities for the rendered image are often computed in a linear color space that has more precision than the frame buffer used to hold the data for the actual displayed image. Typical frame buffers provide a non-linear (gamma-corrected) color space having eight bits for each color component of a given pixel, the eight bits representing a fixed point value between zero and one (inclusive). In other words, common frame buffers store eight bits each for intensities of the red, green and blue color components at each screen pixel. However, the texels in a high dynamic range (HDR) texture bitmap may use more than 8 bits for each color component (e.g., 16 or 32 bits per color component), with those bits representing a floating point value that does not necessarily lie between zero and one. Prior to rendering a displayed image using the mapped texture, a tone-mapping function can be used to convert the higher precision HDR data to a precision and range compatible with the display buffer.

As indicated above, the color components for HDR texels are typically stored as 16- or 32-bit floating point values. However, this can present challenges with current graphics hardware. Although such hardware often supports floating point computations for textures and pixel shaders, bilinear (or trilinear) filtering of floating point texture data is computationally expensive and requires complex texture filtering units. Such filtering units have high gate counts and require substantial silicon area. Such filtering units also consume significant power and provide relatively slow performance. For these and other reasons, most graphics hardware simply does not support filtering for textures stored as floating point values.

### SUMMARY OF THE INVENTION

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

In at least some embodiments, bit patterns storing floating point data values are interpreted as integer values during various processing operations. For example, when bilinearly filtering color intensity data for bitmap regions closest to a designated sampling point, the bit patterns representing each of those color intensities may be interpreted as integers instead of floating point values. As another example, bit patterns may also be treated as integers when trilinearly filtering color intensity data from multiple bitmaps. After processing the bit fields as integers, the results can then be interpreted as floating point values in later computations.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a block diagram of 3D graphics hardware according to at least some embodiments of the invention.

FIGS. 2A-2B illustrate an example of filtering according to at least some embodiments.

FIG. 3 is a flow chart for an algorithm similar to that described in connection with FIG. 2, and which is in some embodiments performed by an IC such as IC 10 of FIG. 1.

FIG. 4 is an HDR image magnified using conventional point sampling.

FIG. 5 is an HDR image is magnified using conventional floating point bilinear filtering.

FIG. 6 is an HDR image magnified using bilinear interpolation of integer values of floating point intensity values.

FIG. 7 shows two images (at different exposures) of 8×8 texels of very bright blue and green colors filtered using a conventional floating point bilinear filter.

FIG. 8 shows two images (at different exposures) of the same pattern from FIG. 7, but which has been bilinearly filtered by treating intensity values as integers.

### DETAILED DESCRIPTION

Embodiments of the invention facilitate processing of graphical data such as high dynamic range (HDR) texture data using simpler hardware than would be required using conventional techniques. As a result, higher quality images can be rendered on a display more quickly. In at least some embodiments, integer bit patterns of floating point data values are filtered. For example, and as described in further detail below, one floating point data format defines the most significant bit of a multi-bit field as a sign bit, a group of the next most significant bits as an exponent, and the least significant bits as a mantissa. When performing a filtering computation using such a multi-bit floating point value, the bits are simply treated as the binary representation of an integer. After filtering operations are performed, the bit patterns of the filtered values are once again treated as floating point values. Although treatment of floating point values as integers is not mathematically equivalent to performing floating point calculations, the results are visually similar to (and in some cases better than) those obtainable from floating point filtering.

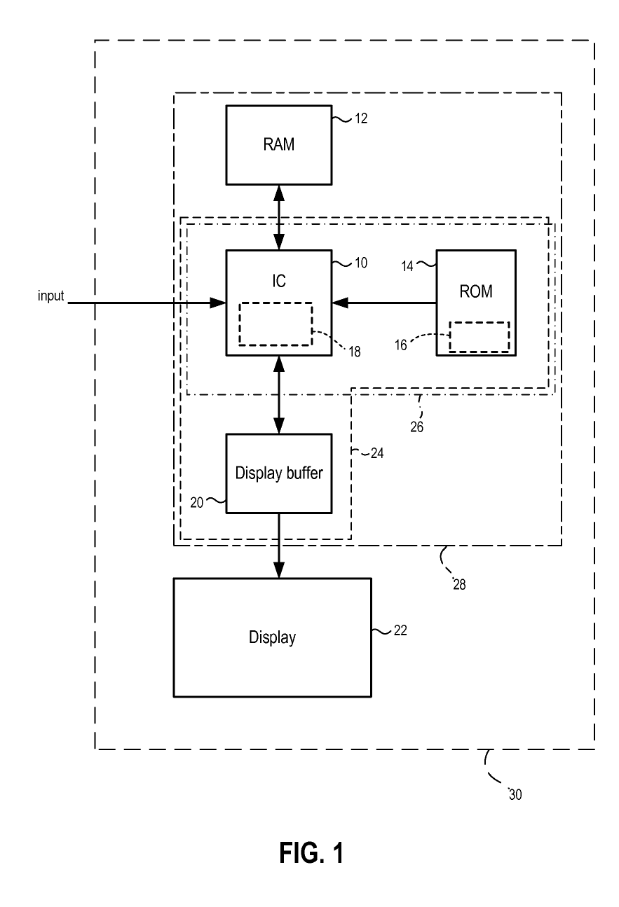

FIG. 1 is a block diagram of 3D graphics hardware according to at least some embodiments of the invention. The hardware of FIG. 1 includes one or more integrated circuit (IC) chips which are configured to process graphical data in one or more of the manners described herein. IC 10 includes control logic for performing calculations, for receiving data input (e.g., graphics to be displayed), for performing read/write operations and for performing other tasks associated with displaying graphical images. Random access memory (RAM) 12 stores image data (e.g., texture files) received and/or processed by IC 10, as well as other data. In at least some embodiments, IC 10 is a microprocessor that accesses programming instructions and/or other data stored in a read only memory (ROM) 14. In some such embodiments, ROM 14 stores programming instructions 16 that cause IC 10 to perform operations according to one or more of the methods described herein. In at least some other embodiments, one or more the methods described herein are hardwired into IC 10. In other words, IC 10 is in such cases an application specific integrated circuit (ASIC) having gates 18 and other logic dedicated to the calculations and other operations described herein. In still other embodiments, IC 10 may perform some operations based on execution of programming instructions read from ROM 14 and/or RAM 12, with other operations hardwired into gates and other logic of IC 10. IC 10 outputs image data to a display buffer 20. In particular, buffer 20 stores data specifying the red, green and blue color component intensities for each pixel of display 22. Display 22 may be, e.g., an LCD display.

For simplicity, FIG. 1 shows IC 10, RAM 12, ROM 14 and display buffer 20 as discrete elements. In some embodiments, however, some or all of these elements may reside on a single IC. The groupings shown with boxes 24, 26 and 28 are but three examples of the manners in which the components could be combined onto a single IC. Other combinations are implemented in other embodiments. In still other embodiments, the functions described in connection with any of IC 10, RAM 12, ROM 14 and display buffer 20 are distributed across multiple ICs.

In at least some embodiments, the hardware of FIG. 1 is incorporated into a larger device 30. Device 30 could be a mobile communication device (e.g., a cellular telephone, a mobile telephone having wireless internet connectivity, or another type of wireless mobile terminal) having a speaker, antenna, communication circuitry, a keypad (and/or other input mechanism(s)), etc. Device 30 could alternatively be a PDA, a notebook computer, a desktop computer (e.g., a PC), a video game console, etc.

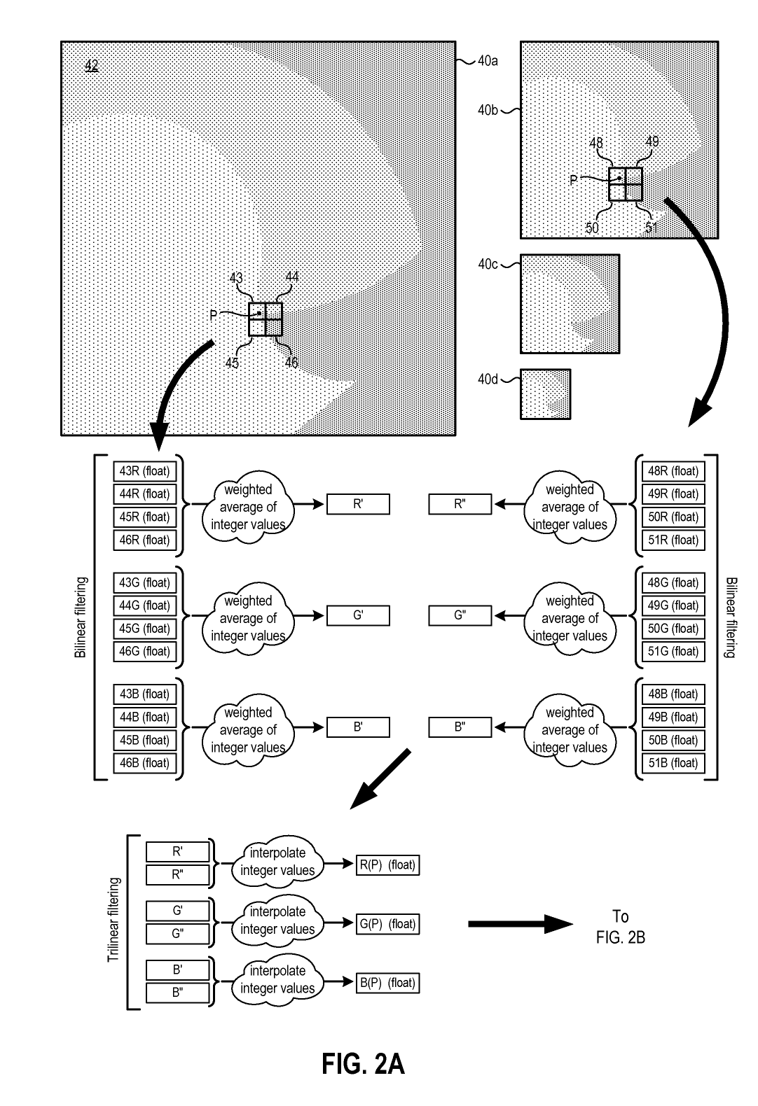

FIGS. 2A-2B illustrate an example of filtering according to at least some embodiments. Shown in FIG. 2A are four bitmaps 40a, 40b, 40c and 40d for a mip-mapping image pyramid corresponding to an arbitrary texture pattern 42. In the example of FIGS. 2A-2B, texture 42 is to be mapped to a surface having a screen pixel size that is smaller than in bitmap 40a, but that is larger than in bitmap 40b. A sampling point P corresponds to a point on the surface to be rendered. Although point P may be an actual screen pixel of the display, this need not be the case. Also shown in FIG. 2A are four regions (represented in FIG. 2A as squares) in each of bitmaps 40a and 40b that are nearest to sampling point P. In bitmap 40A, those regions (or texels) are numbered 43, 44, 45 and 46. In bitmap 40b, the four nearest texels are numbered 48, 49, 50 and 51. Each of the texels 43-46 and 48-51 (as well as other texels in bitmaps 40a, 40b, 40c and 40d) is stored as a set of three 32-bit data values. Each of the 32-bit data values for each texel represents an intensity of a red, green or blue color component.

In the example of FIG. 2A, bit patterns for texel data values are stored as single precision floating point values according to IEEE standard 754. In particular, the most significant bit (MSB) of each bit pattern represents the sign, with 0 indicating a positive value and 1 indicating a negative value. The next eight most significant bits represent a base-2 exponent biased by 127. The remaining 23 bits represent a mantissa. By way of illustration, and when interpreted as a floating point value, the bit pattern “01000010010111011010011100100010” corresponds to a decimal value of 55.413216. For simplicity, the example of FIGS. 2A-2B assumes that all texel data values for bitmaps 40a-40d are positive. Treatment of negative values is discussed below.

When performing filtering calculations on the bit patterns for the texel values of bitmaps 40a and 40b, those bit patterns are not treated as floating point values. Instead, the filtering calculations are performed with the texel bit patterns interpreted as binary representations of integers. Continuing the illustration from above, the bit pattern “01000010010111011010011100100010” represents a decimal value of 1,113,433,890 when interpreted as an integer. For convenience, interpretation of a bit pattern as an integer will also be referred to as using the integer value of that bit pattern.

As further shown in FIG. 2A, bilinear filtering for point P in bitmap 40a yields three 32-bit patterns representing weighted averages of the red, green and blue components of texels 43-46. Beginning at the right side of FIG. 2A under bitmap 40a, bit patterns 43R, 44R, 45R and 46R are the red color component intensities of texels 43-46, and as mentioned above are stored (e.g., in RAM 12 in FIG. 1) as 32-bit floating point values. Bit patterns 43G-46G and 43B-46B are, respectively, values for the green and blue color component intensities of texels 43-46. As also indicated above, bit patterns 43G-46G and 43B-46B (as well as bit patterns for other texels of bitmaps 40a-40d) are also stored as 32-bit floating point values. A weighted average R′ (also a pattern of 32 bits) is calculated by treating values 43R-46R as integers and averaging their integer values based on the position of point P relative to each of texels 43-46. A 32-bit weighted average G′ is calculated by treating values 43G-46G as integers and averaging their integer values based on the position of point P relative to each of texels 43-46. A 32-bit weighted average B′ is calculated by treating values 43B-46B as integers and averaging their integer values based on the position of point P relative to each of texels 43-46.

Bit patterns 48R-51R are the red color component intensities of texels 48-51. Bit patterns 48G-51G and 48B-51B are, respectively, values for the green and blue color component intensities of texels 48-51. A similar bilinear filtering for point P in bitmap 40b yields three 32-bit values R″, G″ and B″ for the weighted averages of the red, green and blue components of texels 48-51.

Trilinear filtering is then performed by interpolating between the 32-bit bilinearly-filtered color intensity values for bitmaps 40a and 40b, with those values (R′, R″, G′, G″, B′, B″) again treated as integers. The interpolation is based on relative sizes of bitmaps 40a and 40b and of the surface onto which the texture is being mapped. Integer values of the bit patterns R′ and R″ are interpolated to yield a 32-bit value R(P). In a similar fashion, G′ and G″ are interpolated to yield G(P), and B′ and B″ are interpolated to yield B(P). Similar bilinear and trilinear filtering operations are performed for other sampling points and other texels.

The trilinearly-filtered values R(P), G(P) and B(P) (as well as similarly obtained values for other sampling points) may then be subjected to further processing (e.g., pixel shading, anisotropic filtering, etc.). In some embodiments, at least some portions of that processing also treats bit patterns representing color intensity values as integers. In other embodiments, the additional processing treats 32-bit color intensity values as floating point values. Ultimately, and as shown in FIG. 2B, the processed color intensity values are used to control the pixels of a display screen (e.g., display 22 of FIG. 1).

As indicated above, the example of FIGS. 2A-2B assumes that all texel values are positive. For negative texel color intensity values, additional steps are performed. Because a MSB of “1” is used to indicate that a floating point value is negative, that bit can be masked out before interpreting the bits of a negative color intensity value as an integer. Otherwise, the “1” MSB would (for 32-bit floating point values) increase the integer value of the color intensity by 2,147,483,648 (i.e., 2³¹). The sign of the color intensity can be preserved by, e.g., a separately-stored flag. As another alternative, integer values may be transformed, prior to filtering, so that the entire numeric range of intensity values is continuous in the integer domain. For example, and if intensities are stored with 16 bits, the 15 least significant bits could be inverted for non-negative values before and after filtering. In many circumstances, however, provision for negative values is not needed.

In some cases, negative numbers could be obtained from mathematical look-up tables. In some such cases, and if interpolation of arbitrary look-up table values is required, conventional bilinear interpolation and/or pixel shading could be used.

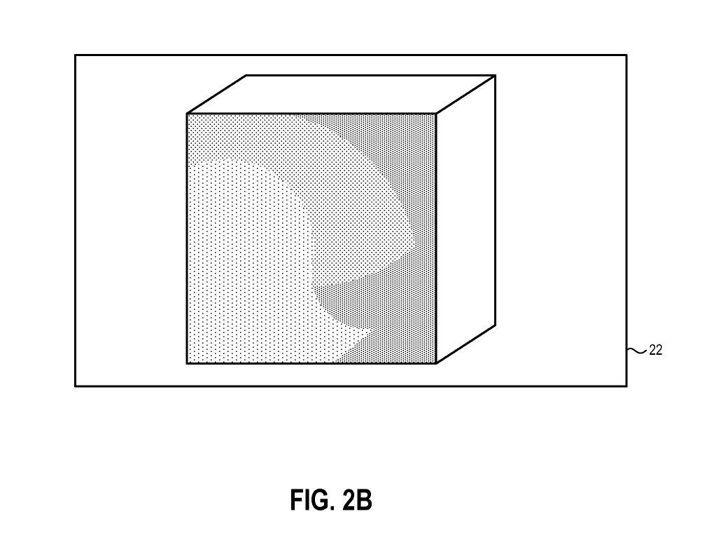

FIG. 3 is a flow chart for an algorithm similar to that described in connection with FIGS. 2A-2B, and which is in some embodiments performed by an IC such as IC 10 of FIG. 1. In block 101, the bit maps of a texture image pyramid appropriate for mip-mapping that texture to particular surface are identified. In step 102, a sampling point P within each of the identified texture bitmaps is selected. In step 103, the texels closest to the sampling point P in the first identified bitmap are located. Each of the texels is represented by three bit patterns storing floating point values: a value for a red color component intensity, a value for a green color component intensity, and a value for a blue color component intensity. In block 108, a weighted average is calculated using the integer values of the bit patterns representing the red color component intensities of the texels located in block 103. Similar weighted averages are calculated for the green and blue intensities in blocks 109 and 110, respectively.

The algorithm then proceeds to block 113, where the four texels of the second identified bitmap closest to sampling point P are located. The algorithm then proceeds through blocks 115-117, where weighted averages are calculated using the integer values of the bit patterns representing the red, green and blue color component intensities of the texels located in block 113. The algorithm next proceeds to block 121. In block 121, the results from blocks 108 and 115 are interpolated. In block 122, the results from blocks 109 and 116 are interpolated. In block 123, the results from blocks 110 and 117 are interpolated. In blocks 126-128, additional processing may be performed on the interpolated values from blocks 121-123. As indicated above, this additional processing could include pixel shading, additional filtering, etc. Blocks 126-128 are shown in broken lines to indicate that some or all of the additional processing may be omitted.

The algorithm then proceeds to block 130 and determines if there are additional sampling points to be processed. If so, the algorithm proceeds on the “yes” branch to block 102 and repeats the above-described operations. If there are no additional sampling points to process, the algorithm proceeds on the “no” branch. As indicated by the ellipsis in FIG. 3, the texel data may then be further processed. In block 131, the texel data (or further processed data based on the texel data) is used to generate an image on a display.

There are numerous variations on the above described processing in other embodiments. For example, the sampling point P could be mapped to other bitmaps of the texture image pyramid (e.g., to bitmaps 40b and 40c or to bitmaps 40c and 40d). The bilinear and trilinear filtering could be performed in the opposite order, and/or additional (and/or different types) of filtering performed. Although the above examples were described using single precision IEEE floating point format, other types of floating point formats could be used.

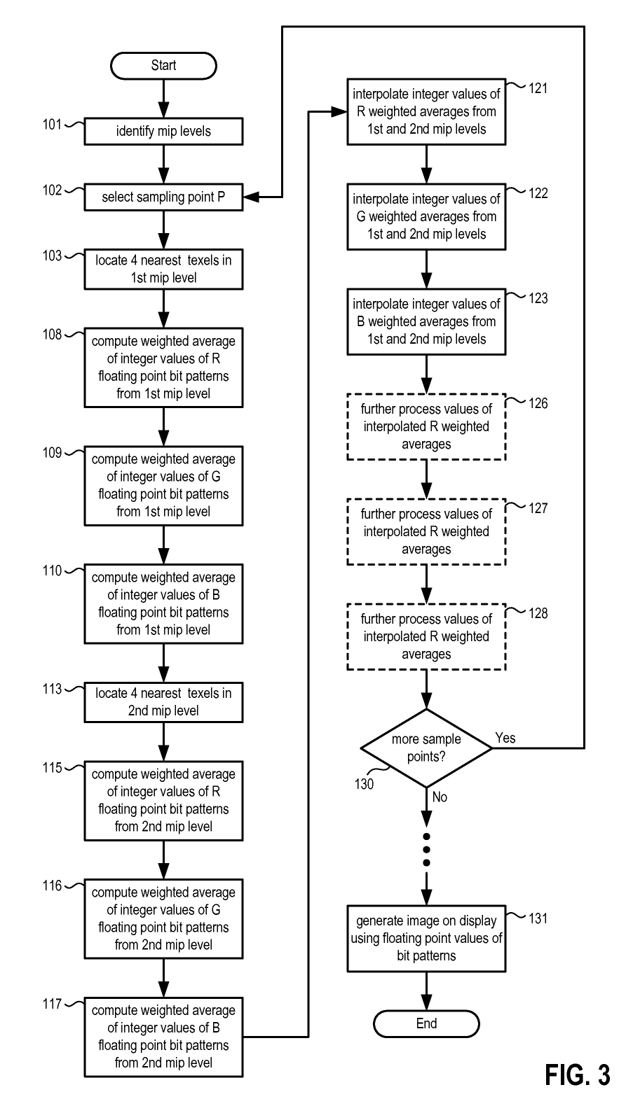

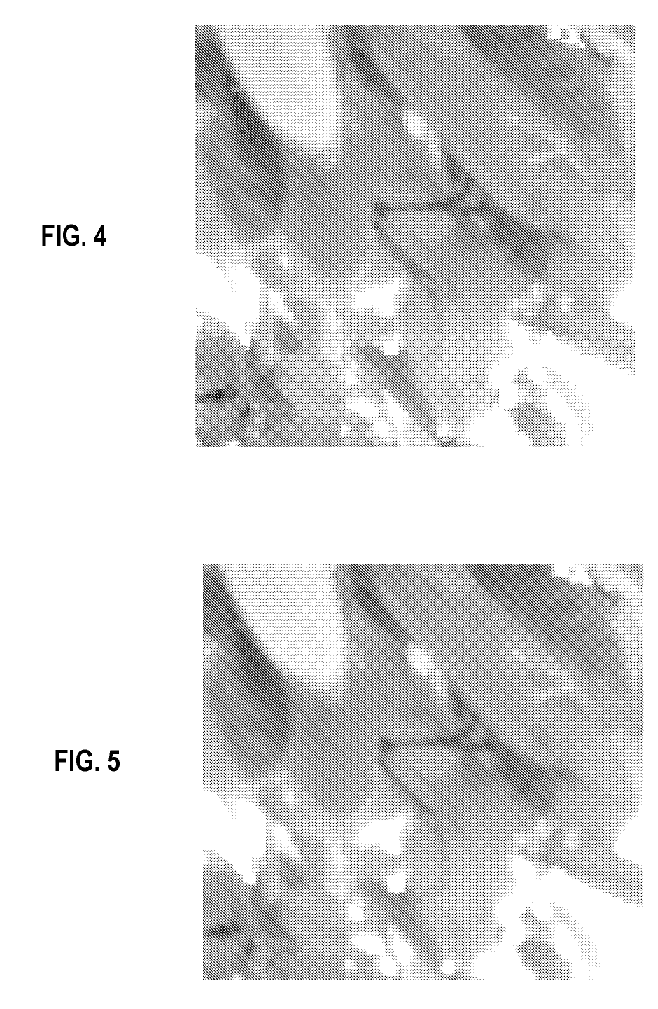

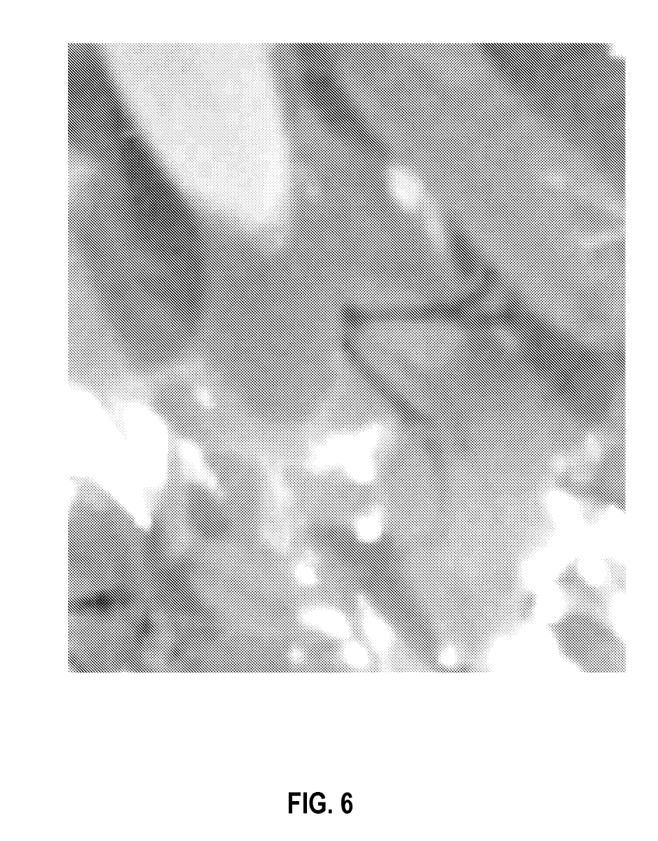

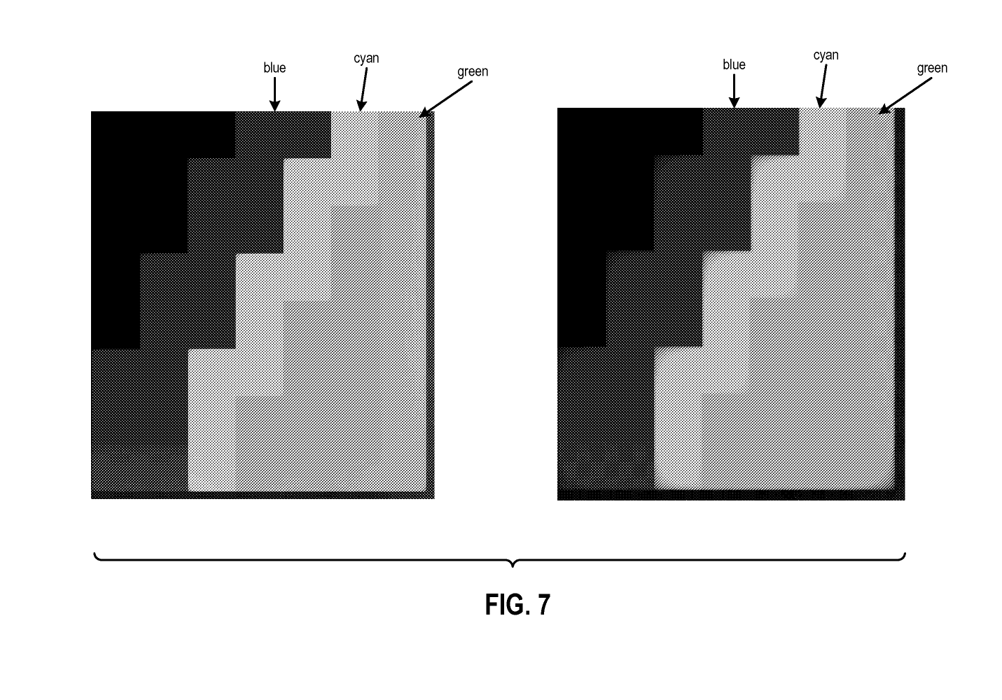

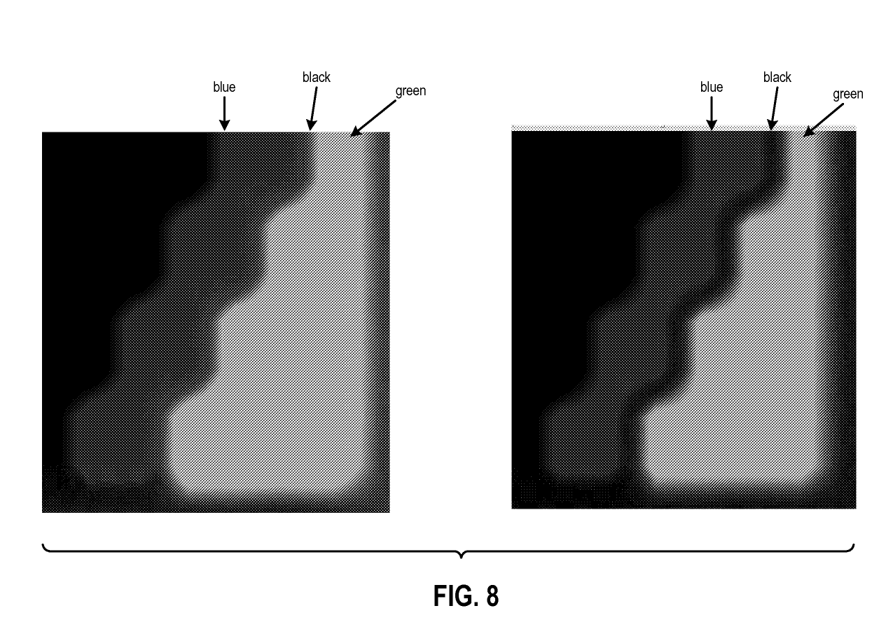

Because calculations with integers can be performed much faster than and with fewer operations than calculations with floating point values, the processing techniques described above permit higher quality rendering without the additional processing requirements associated with floating point calculations. FIGS. 4-8, which are color images that have been printed in black and white, demonstrate results of image processing using techniques such as are described above. FIG. 4 is a high dynamic range (HDR) image magnified using conventional point sampling. FIG. 5 is an HDR image that is magnified using conventional floating point bilinear filtering. The saturated regions of the image include jagged edges despite the interpolation. FIG. 6 is an HDR image magnified using bilinear interpolation of integer values of floating point intensity values. The non-linearity of the integer value interpolation produces smother highlights while maintaining the appearance in other regions of the image. FIG. 7 shows an 8×8-texel image, containing very bright blue and green pixels, at two different exposures and a very large magnification, filtered using a conventional bilinear filter. Most of the intensity values are saturated to blue or green, and a cyan halo (not present in the original image) is generated. FIG. 8 is otherwise the same as FIG. 7, but the images have been produced by bilinear filtering such that the intensity values are treated as integers. Although a dark halo is generated, the overall result is smoother.

Techniques in accordance with various embodiments of the invention can be implemented in numerous ways. For example, existing graphical processing software can be modified to include such techniques. As one illustration of such a modification, Appendix A contains code which can be added to source code for the “exrdisplay” program (available from Industrial Light & Magic, a division of Lucas Digital Ltd. LLC of California, USA), which program can be used to display images in the OPENEXR format. Persons skilled in the art could insert the code in Appendix A into the proper location of the exrdisplay program without undue experimentation.

Although specific examples of carrying out the invention have been described, those skilled in the art will appreciate that there are numerous variations and permutations of the above-described systems and methods that are contained within the spirit and scope of the invention as set forth in the appended claims. As but one example, bilinear filtering is in some embodiments performed using integer values of bit patterns, but trilinear filtering is performed using floating point values of bit patterns. These and other modifications are within the scope of the invention as set forth in the attached claims. In the claims, various portions are prefaced with letter or number references for convenience. However, use of such references does not imply a temporal relationship not otherwise required by the language of the claims.

APPENDIX A

| | |
|---|---|
| bool bFilterUsingFloats = false; | // boolean or integer filtering |
| float ratioX = 0.5f; | // scaling factors |
| float ratioY = 0.5f; | |
| Array<Rgba> scaled (w*h); | // filtered image |

```
int limitX = w;
int limitY = h;
if (ratioX >= 1.0f) {
  limitX = w/ratioX;
}
if (ratioY >= 1.0f) {
  limitY = h/ratioY;
}
float fractionX, fractionY, oneMinusX, oneMinusY;
int ceilX, ceilY, floorX, floorY;
Rgba c1, c2, c3, c4, result;
for (int x = 0; x < limitX; ++x) {
  for (int y = 0; y < limitY; ++y) {
    floorX = (int)floor(x*ratioX);
    floorY = (int)floor(y*ratioY);
    ceilX = floorX + 1;
    if (ceilX >= w) {
      ceilX = floorX;
    }
    ceilY = floorY + 1;
    if (ceilY >= h) {
      ceilY = floorY;
    }
    fractionX = x * ratioX − floorX;
    fractionY = y * ratioY − floorY;
    oneMinusX = 1.0 − fractionX;
    oneMinusY = 1.0 − fractionY;
    c1 = mainWindow->pixels[(floorY*w)+floorX];
    c2 = mainWindow->pixels[(floorY*w)+ceilX];
    c3 = mainWindow->pixels[(ceilY*w)+floorX];
    c4 = mainWindow->pixels[(ceilY*w)+ceilX];
    if (bFilterUsingFloats) {  // filter using 16-bit halfs
      half b1, b2;
      // R
      b1 = (half)(oneMinusX * c1.r + fractionX * c2.r);
      b2 = (half)(oneMinusX * c3.r + fractionX * c4.r);
      result.r = (half)(oneMinusY * float(b1) + fractionY * float(b2));
      // G
      b1 = (half)(oneMinusX * c1.g + fractionX * c2.g);
      b2 = (half)(oneMinusX * c3.g + fractionX * c4.g);
      result.g = (half)(oneMinusY * float(b1) + fractionY * float(b2));
      // B
      b1 = (half)(oneMinusX * c1.b + fractionX * c2.b);
      b2 = (half)(oneMinusX * c3.b + fractionX * c4.b);
      result.b = (half)(oneMinusY * float(b1) + fractionY * float(b2));
      scaled[(y*w)+x] = result;
    } else {  // filter using 16-bit shorts
      unsigned short temp1, temp2;
      // R
      temp1 = (unsigned short)(oneMinusX * c1.r.bits( ) + fractionX *
            c2.r.bits( ));
      temp2 = (unsigned short)(oneMinusX * c3.r.bits( ) + fractionX *
            c4.r.bits( ));
      result.r.setBits((oneMinusY * temp1) + (fractionY * temp2));
      // G
      temp1 = (unsigned short)(oneMinusX * c1.g.bits( ) + fractionX *
            c2.g.bits( ));
      temp2 = (unsigned short)(oneMinusX * c3.g.bits( ) + fractionX *
            c4.g.bits( ));
      result.g.setBits((oneMinusY * temp1) + (fractionY * temp2));
      // B
      temp1 = (unsigned short)(oneMinusX * c1.b.bits( ) + fractionX *
            c2.b.bits( ));
      temp2 = (unsigned short)(oneMinusX * c3.b.bits( ) + fractionX *
            c4.b.bits( ));
      result.b.setBits((oneMinusY * temp1) + (fractionY * temp2));
      scaled[(y*w)+x] = result;
    }
  }
}
// replace the original image with the scaled one
for (int i = 0; i < w*h; ++i) {
  mainWindow->pixels[i] = scaled[i];
}
```

1. A method of processing graphic data to generate an image on a display, comprising:
(a) identifying image data corresponding to multiple regions of at least one bitmap, wherein the image data corresponding to each of the multiple regions includes at least one bit pattern storing a floating point data value;
(b) calculating a bit pattern associated with the multiple regions using an integer value of each of the at least one bit patterns; and
(c) generating a bit pattern to display an image corresponding to the at least one bitmap, wherein the generated bit pattern is based on the bit pattern calculated in (b).

2. The method of claim 1, wherein
the image data identified in (a) includes intensity values for a color component of texture bitmap texels located near a sampling point, and
the bit pattern calculated in (b) is a weighted average of the color component intensity values.

3. The method of claim 2, wherein (a) comprises identifying image data corresponding to multiple regions of a first bitmap, and comprising
(d) identifying bit patterns storing floating point values for color component intensities of texels in a second bitmap;
(e) calculating a weighted average associated with regions of the second bitmap using an integer value of each of the bit patterns identified in (d); and
(f) interpolating between the results of (b) and (e) so as to obtain an interpolated bit pattern, and wherein (c) includes generating a bit pattern to display an image based on the interpolated bit pattern.

4. The method of claim 1, wherein
the at least one bitmap is a first bitmap of a mip-mapping image pyramid,
the at least one bit pattern for each of the multiple regions is a color component intensity value for a region of the first bitmap, and
step (b) includes bilinearly filtering the color component intensity values for first bitmap regions.

5. The method of claim 4, comprising:
(d) bilinearly filtering color component intensity values for regions of a second bitmap of the mip-mapping image pyramid, wherein the color component intensity values for the second bitmap regions are bit patterns storing floating point data values, and wherein the bit patterns for second bitmap regions are treated as integers during said bilinear filtering; and
(e) linearly filtering the results of steps (b) and (d) to achieve trilinear filtering.

6. The method of claim 5, wherein (e) comprises trilinearly filtering using integer values of bit patterns forming the results of steps (b) and (d).

7. The method of claim 4, comprising
(d) prior to (a), identifying a sampling point in the first bitmap corresponding to a screen pixel on which a portion of a graphical surface is to be rendered and to which a texture represented by mip-mapping image pyramid is to be mapped.

8. A machine-readable medium having machine-executable instructions for performing a method for processing graphic data to generate an image on a display, comprising:
(a) identifying image data corresponding to multiple regions of at least one bitmap, wherein the image data corresponding to each of the multiple regions includes at least one bit pattern storing a floating point data value;
(b) calculating a bit pattern associated with the multiple regions using an integer value of each of the at least one bit patterns; and
(c) generating a bit pattern to display an image corresponding to the at least one bitmap, wherein the generated bit pattern is based on the bit pattern calculated in (b).

9. The machine-readable medium of claim 8, wherein
the image data identified in (a) includes intensity values for a color component of texture bitmap texels located near a sampling point, and
the bit pattern calculated in (b) is a weighted average of the color component intensity values.

10. The machine-readable medium of claim 9, wherein (a) comprises identifying image data corresponding to multiple regions of a first bitmap, and comprising additional instructions for
(d) identifying bit patterns storing floating point values for color component intensities of texels in a second bitmap;
(e) calculating a weighted average associated with regions of the second bitmap using an integer value of each of the bit patterns identified in (d); and
(f) interpolating between the results of (b) and (e) so as to obtain an interpolated bit pattern, and wherein (c) includes generating a bit pattern to display an image based on the interpolated bit pattern.

11. The machine-readable medium of claim 8, wherein
the at least one bitmap is a first bitmap of a mip-mapping image pyramid,
the at least one bit pattern for each of the multiple regions is a color component intensity value for a region of the first bitmap, and
step (b) includes bilinearly filtering the color component intensity values for first bitmap regions.

12. The machine-readable medium of claim 11, comprising additional instructions for
(d) bilinearly filtering color component intensity values for regions of a second bitmap of the mip-mapping image pyramid, wherein the color component intensity values for the second bitmap regions are bit patterns storing floating point data values, and wherein the bit patterns for second bitmap regions are treated as integers during said bilinear filtering; and
(e) linearly filtering the results of steps (b) and (d) to achieve trilinear filtering.

13. The machine-readable medium of claim 12, wherein (e) comprises trilinearly filtering using integer values of bit patterns forming the results of steps (b) and (d).

14. The method of claim 11, comprising additional instructions for
(d) prior to (a), identifying a sampling point in the first bitmap corresponding to a screen pixel on which a portion of a graphical surface is to be rendered and to which a texture represented by mip-mapping image pyramid is to be mapped.

15. A device, comprising:
one or more integrated circuits configured to perform a method for processing graphic data to generate an image on a display, the method including
(a) identifying image data corresponding to multiple regions of at least one bitmap, wherein the image data corresponding to each of the multiple regions includes at least one bit pattern storing a floating point data value,
(b) calculating a bit pattern associated with the multiple regions using an integer value of each of the at least one bit patterns, and
(c) generating a bit pattern to display an image corresponding to the at least one bitmap, wherein the generated bit pattern is based on the bit pattern calculated in (b).

16. The device of claim 15, wherein
the image data identified in (a) includes intensity values for a color component of texture bitmap texels located near a sampling point, and
the bit pattern calculated in (b) is a weighted average of the color component intensity values.

17. The device of claim 16, wherein (a) comprises identifying image data corresponding to multiple regions of a first bitmap, and wherein the one or more integrated circuits are further configured to
(d) identify bit patterns storing floating point values for color component intensities of texels in a second bitmap,
(e) calculate a weighted average associated with regions of the second bitmap using an integer value of each of the bit patterns identified in (d), and
(f) interpolate between the results of (b) and (e) so as to obtain an interpolated bit pattern, and wherein (c) includes generating a bit pattern to display an image based on the interpolated bit pattern.

18. The device of claim 15, wherein
the at least one bitmap is a first bitmap of a mip-mapping image pyramid,
the at least one bit pattern for each of the multiple regions is a color component intensity value for a region of the first bitmap, and
step (b) includes bilinearly filtering the color component intensity values for first bitmap regions.

19. The device of claim 18, wherein the one or more integrated circuits are further configured to
(d) bilinearly filter color component intensity values for regions of a second bitmap of the mip-mapping image pyramid, wherein the color component intensity values for the second bitmap regions are bit patterns storing floating point data values, and wherein the bit patterns for second bitmap regions are treated as integers during said bilinear filtering, and
(e) linearly filter the results of steps (b) and (d) to achieve trilinear filtering.

20. The device of claim 19, wherein (e) comprises trilinearly filtering using integer values of bit patterns forming the results of steps (b) and (d).

21. The device of claim 18, wherein the one or more integrated circuits are further configured to
(d) prior to (a), identify a sampling point in the first bitmap corresponding to a screen pixel on which a portion of a graphical surface is to be rendered and to which a texture represented by mip-mapping image pyramid is to be mapped.

22. The device of claim 15, wherein the device is a mobile communication device.

23. The device of claim 15, wherein the device is a computer.

24. The device of claim 15, wherein the device is a video game console.

25. A device, comprising:
means for storing a mip-mapping image pyramid; and
means for bilinearly filtering texels of bitmaps of the image pyramid, said filtering including processing bit patterns storing floating point values as integers.

26. The device of claim 25, comprising:
means for trilinearly filtering bit patterns corresponding to separate bitmaps of the image pyramid, said trilinear filtering including processing the bilinearly filtered bit patterns as integers.
